(19) United States
(12) Patent Application Publication
(10) Pub. No.: US 2016/0292487 A1
(43) Pub. Date: Oct. 6, 2016

(54) ARRAY SUBSTRATE, COLOR FILM SUBSTRATE AND TOUCH DISPLAY DEVICE

(71) Applicants: Shanghai Tianma Micro-Electronics Co., Ltd., Shanghai (CN); Tianma Micro-Electronics Co., Ltd., Shenzhen (CN)

(72) Inventors: Yungang Sun, Shanghai (CN); Zhongshou Huang, Shanghai (CN); Kang Yang, Shanghai (CN); Xueying Piao, Shanghai (CN)

(21) Appl. No.: 14/988,572

(22) Filed: Jan. 5, 2016

(30) Foreign Application Priority Data
Apr. 1, 2015 (CN) 201510152976.5

(51) Int. Cl. G06K 9/00; G06F 3/044; G06F 3/041

(52) U.S. Cl. CPC G06K 9/0002; G06F 3/0412; G06F 3/044; G06F 3/0416; G06F 2203/04111

(57) ABSTRACT

An array substrate, including: a display area and a non-display area, multiple gate lines, multiple data lines and a drive chip arranged in the non-display area, and a common electrode layer arranged in the display area, where the gate lines are insulated from and intersect with the data lines to define multiple pixel units arranged in an array, each of the multiple pixel units includes a pixel thin film transistor and a pixel electrode; the common electrode layer includes multiple insulated first touch units, each of the multiple first touch units corresponds to multiple the pixel units; and a first fingerprint identification unit is arranged on the array substrate for identifying a fingerprint

### CROSS REFERENCE OF RELATED APPLICATION

The present application claims the priority to Chinese Patent Application No. 201510152976.5, entitled “ARRAY SUBSTRATE, COLOR FILM SUBSTRATE AND TOUCH DISPLAY DEVICE”, filed on Apr. 1, 2015 with the State Intellectual Property Office of the PRC, which is incorporated herein by reference in its entirety.

### BACKGROUND

With the increasing development of electronic devices, fingerprint identification is becoming a competitive feature of electronic devices. At present, common fingerprint recognition devices typically include optical fingerprint sensing devices and semiconductor fingerprint sensing devices. The optical fingerprint sensing device is typically bulky, therefore its application is limited. Semiconductor fingerprint sensing devices have advantages of low price, small size and high identification rate and are therefore increasingly used in various electronic devices.

Undoubtedly, a semiconductor fingerprint sensing device in combination with a display device may further provide a series of advantageous feature. For example, the fingerprint sensing device may be adapted to relatively safely perform operations such as turning on and off the display device.

However, traditionally in order to combine the display device and the fingerprint sensing device together, both are simply collectively arranged. For example, the display device and the fingerprint sensing device may be arranged in a housing of the same electronic device. This simple collective structure may result in issues such as a lower screen proportions, increased thickness (volume) and increased costs of manufacturing the electronic device.

### BRIEF SUMMARY

This specification relates to an array substrate, a color film substrate and a touch display device. An array substrate, a color film substrate, and a touch display device are provided according to the present disclosure, to implement fingerprint identification with high screen proportions.

To achieve the above objects, the technical solutions as follows are provided according to the disclosure. An array substrate is provided, which includes a display area and a non-display area, where multiple gate lines, multiple data lines and a drive chip are arranged in the non-display area, and a common electrode layer is arranged in the display area, the multiple gate lines are insulated from and intersect with the multiple data lines to define multiple pixel units arranged in an array, where each of the multiple pixel units includes a pixel thin film transistor and a pixel electrode; the common electrode layer includes multiple insulated first touch units, each of the multiple first touch units corresponds to multiple pixel units; and the array substrate further includes a first fingerprint identification unit for identifying a fingerprint.

A color film substrate is provided, which includes a color film layer arranged in a display area and configured to color filter one or more light rays; and a second fingerprint identification unit configured to identify a fingerprint.

A touch display device is provided, which includes an array substrate and a color film substrate arranged opposite to each other; and a display medium arranged between the array substrate and the color film substrate, where the array substrate is the array substrate according to any one of the above, or the color film substrate is the color film substrate according to any one of the above.

It is understood from the above technical solutions that an array substrate is provided according to the present disclosure, which includes a display area and a non-display area, where multiple gate lines, multiple data lines and a drive chip are arranged in the non-display area, and a common electrode layer is arranged in the display area, the gate lines are insulated from and intersect with the data lines to define multiple pixel units arranged in an array, each of the multiple pixel units includes a pixel thin film transistor and a pixel electrode; the common electrode layer includes multiple insulated first touch units, each of the multiple first touch units corresponds to multiple pixel units; and a first fingerprint identification unit is arranged on the array substrate for identifying a fingerprint. Thus, as compared with the prior art in which the fingerprint identification unit is simply arranged in the electronic device, the array substrate according to the present disclosure in which the fingerprint identification unit is included has a higher screen proportion and a smaller thickness.

A color film substrate is further provided according to the present disclosure. The fingerprint identification unit is also arranged on the color film substrate to implement fingerprint identification with high screen proportion.

A touch display device is further provided according to the present disclosure, which includes the above mentioned array substrate. Therefore, as compared to the prior art in which the fingerprint identification unit is simply arranged in the electronic device, the touch display device in the disclosure has a higher screen proportion and a smaller thickness.

### BRIEF DESCRIPTION OF THE DRAWINGS

The drawings to be used in the description of embodiments or the conventional technology are described herein. Drawings associated with the following description only illustrate some embodiments of the present disclosure. For those skilled in the art, other drawings may be obtained based on these drawings without any creative work.

FIG. 1 is a schematic structural diagram of an array substrate according to an embodiment of the present application;

FIG. 2 is a schematic structural diagram of an array substrate according to an embodiment of the present application;

FIG. 3 is a schematic structural diagram of an array substrate according to an embodiment of the present application;

FIG. 4 is a schematic structural diagram of an array substrate according to an embodiment of the present application;

FIG. 5 is a schematic structural diagram of an array substrate according to an embodiment of the present application;

FIG. 6 is a schematic structural diagram of an array substrate according to an embodiment of the present application;

FIG. 7 is a schematic structural diagram of an array substrate according to an embodiment of the present application;

FIG. 8 is a schematic structural diagram of an array substrate according to an embodiment of the present application;

FIG. 9 is a schematic structural diagram of an array substrate according to an embodiment of the present application;

FIG. 10 is a schematic structural diagram of an array substrate according to an embodiment of the present application; and

FIG. 11 is a schematic structural diagram of an array substrate according to an embodiment of the present application.

### DETAILED DESCRIPTION OF THE EMBODIMENTS

Technical solutions according to embodiments of the present disclosure are described hereinafter in conjunction with the drawings. It is obvious that the described embodiments are only a part rather than all of the embodiments according to the present disclosure. Any other embodiments obtained by those skilled in the art based on the embodiments in the present disclosure without any creative work fall in the scope of the present disclosure.

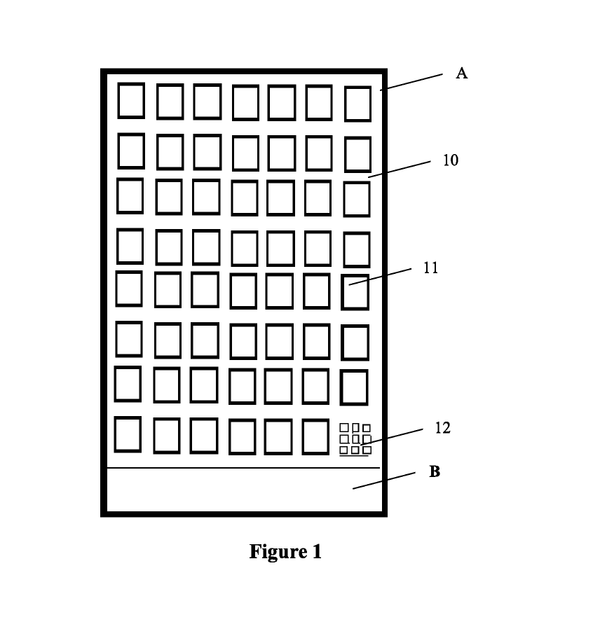

Referring to FIG. 1, an array substrate is provided according to the present disclosure, which includes a display area A and a non-display area B. Multiple gate lines, multiple data lines and a drive chip are arranged in the non-display area, and a common electrode layer 10 are arranged in the display area. The gate lines are insulated from and intersect with the data lines to define multiple pixel units arranged in an array, and each of the multiple pixel units includes a pixel thin film transistor and a pixel electrode. The common electrode layer includes multiple insulated first touch units 11, and each of the multiple first touch units corresponds to multiple pixel units. A first fingerprint identification unit 12 is arranged on the array substrate for identifying a fingerprint. Thus, as compared to the prior art in which the fingerprint identification unit is simply arranged in the electronic device, the array substrate according to the present disclosure in which the fingerprint identification unit is included has a higher screen proportions and a smaller or thinner thickness.

Optionally, the first fingerprint identification unit 12 is arranged in a same layer with the first touch unit 11. In this case, the fingerprint identification unit may be integrated into the common electrode layer, and the thickness of the screen is reduced.

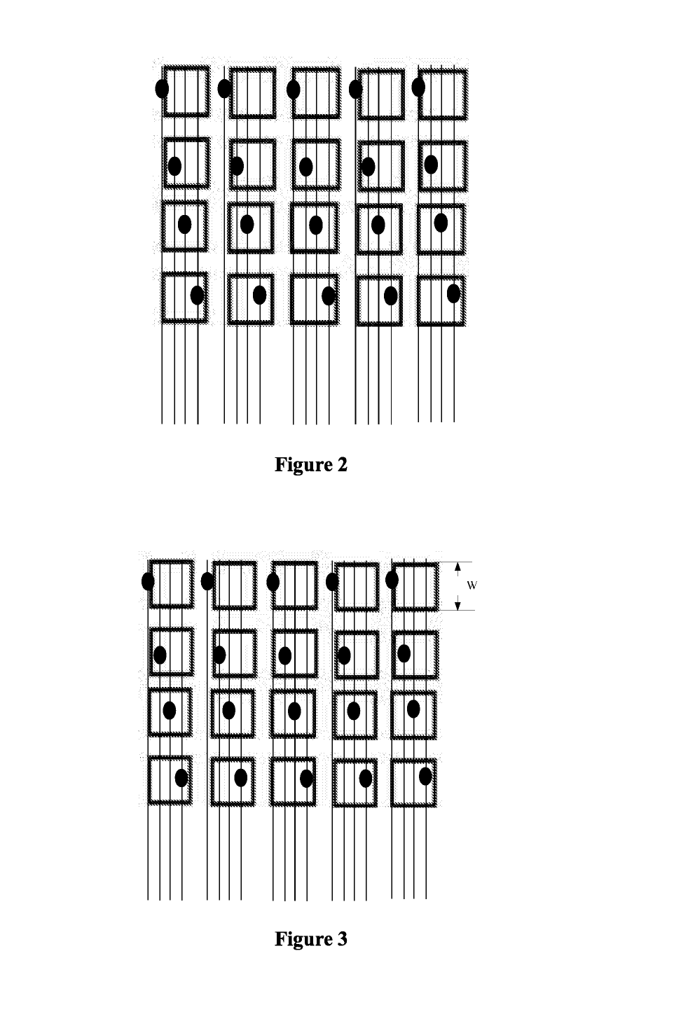

In addition, two implementations of fingerprint identification are provided according to the present embodiment. As shown in FIG. 2, the first fingerprint identification unit 12 includes multiple first fingerprint sensing units arranged in an array, and each of the multiple first fingerprint sensing units is electrically connected to the drive chip via a wire. Optionally, as shown in FIG. 3, a longest side W1 of the first fingerprint sensing unit has a length less than 100 μm, so as to identify ridges of a fingerprint by the first fingerprint identification unit. If the longest side W1 of the first fingerprint identification unit has a length greater than the width of the fingerprint, the fingerprint cannot be identified.

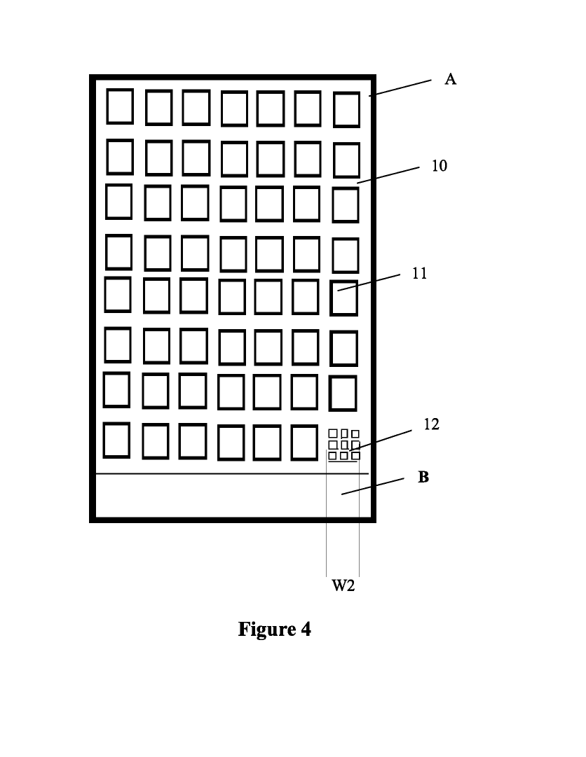

Taking the width of an average persons finger into account, optionally, a length W2 of the first fingerprint identification unit may be set to be greater than or equal to 2 mm, as shown in FIG. 4.

Particularly, in an embodiment, the first fingerprint identification unit may be arranged at any position in the common electrode layer. As shown in FIG. 1, the first fingerprint identification unit 12 is arranged at the lower right corner of the multiple first touch electrode arranged in an array in the common electrode layer. In addition, the first fingerprint identification unit may be arranged at the position of any of the first touch electrodes as shown in FIG. 1.

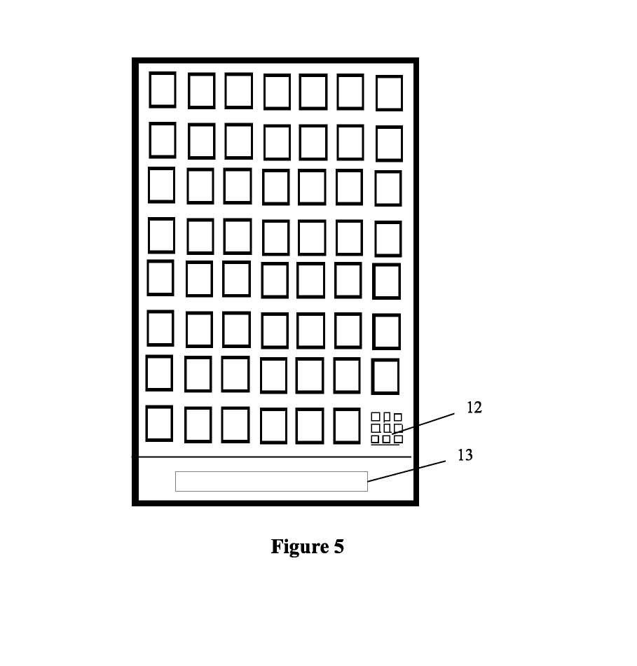

Optionally, as shown in FIG. 5, the first fingerprint identification unit 12 is arranged on a side of the display area closer to the drive chip 13.

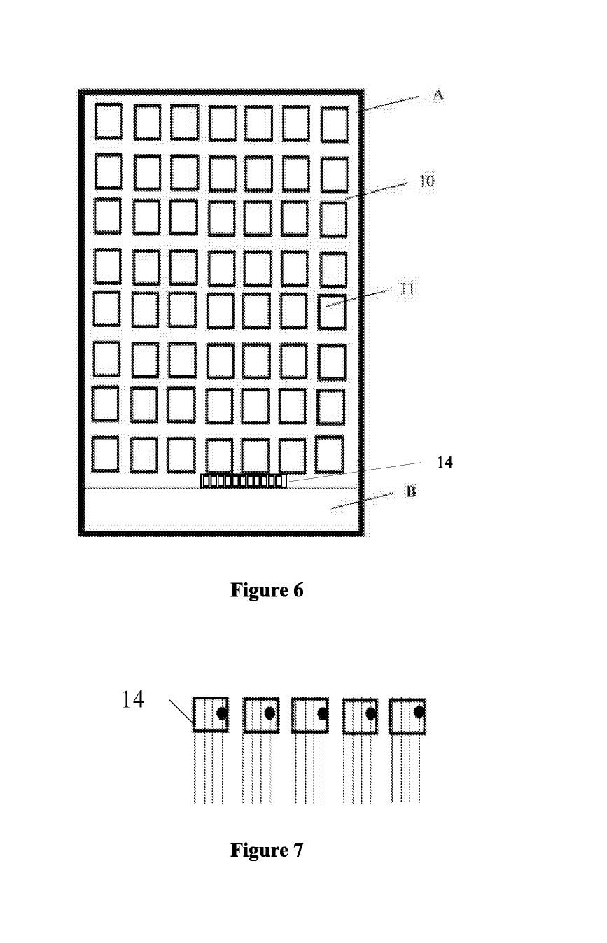

Another fingerprint identification method according to an embodiment is shown in FIG. 6 and FIG. 7. The first fingerprint identification unit is a first swipe-type fingerprint sensing unit 14, which includes the multiple first fingerprint sensing units arranged sequentially in a single row, and each of the multiple first fingerprint sensing units is electrically connected to the drive chip via a wire.

In this fingerprint identification method, the first fingerprint identification unit may be arranged on any side of the display area. Optionally, the first fingerprint identification unit is arranged on a side of the display area closer to the drive chip.

As shown in FIG. 11, which is an enlarged view of FIG. 7, the principle for fingerprint identification is as follows. When the finger slides in the direction indicated by 1301, the fingerprint identification unit identifies the capacitance between the touch electrodes and the finger, and generates touch signals whose strength distributions are recorded on an integration stripe. Then a fingerprint pattern of the finger is generated according to the signal strength distribution recorded on the stripe at different time points in the finger slide process. Optionally, the fingerprint identification unit 1302 has a width which is greater than the width of the finger and may be greater than or equal to 2 mm. The fingerprint sensing unit 1303 may have a width of 40 to 50 micron, so that the fingerprint is identified more accurately.

According to the arrangement of electrodes of the first touch unit, the array substrate according to the present embodiment may be a mutual-capacitive array substrate or a self-capacitive array substrate. If the first touch unit includes insulated touch electrodes which are arranged in a same layer, the array substrate is the self-capacitive array substrate. If the first touch unit includes first touch electrodes and second touch electrodes, the first touch electrodes are arranged sequentially in a first direction in the display area, and the second touch electrodes are arranged sequentially in a second direction in the display area, the array substrate is the mutual-capacitive array substrate.

It should be noted that the array substrate according to the present embodiment may be either the mutual-capacitive array substrate or the self-capacitive array substrate, which will not be limited herein.

A color film substrate is further provided in an embodiment, which includes a color film layer arranged in a display area and configured to color filter one or more light rays; and a second fingerprint identification unit configured to identify a fingerprint.

Optionally, the second fingerprint identification unit includes multiple second fingerprint sensing units, and a longest side of the second fingerprint sensing unit has a length less than 100 μm. The fingerprint identification unit may be arranged on at least one side of the display area. The fingerprint identification unit may be arranged on a side of the display area closer to the drive chip. The multiple second fingerprint sensing units may be arranged in an array, and each of the multiple second fingerprint sensing units may be electrically connected to the drive chip via a wire.

Optionally, the second fingerprint identification unit may be a second swipe-type fingerprint sensing unit, which includes the multiple second fingerprint sensing units arranged sequentially in a single row, and each of the multiple fingerprint sensing units may be electrically connected to the drive chip via a wire.

For features of the color film substrate provided according to the present embodiment, reference may be made to the above features of the array substrate. The fingerprint identification unit is also arranged on the color film substrate to implement fingerprint identification with higher screen proportions.

A touch display device is further provided according to the present disclosure. The touch display device includes an array substrate and a color film substrate arranged opposite to each other; and a display medium arranged between the array substrate and the color film substrate. The array substrate is any one of the array substrates described above, or the color film substrate is any one of the color film substrate described above.

Particularly, in the above embodiments, the touch electrode layer is implemented by reusing the common electrode layer. However, the common electrode layer may be only used for display control. In the case where the common electrode layer is only used for display control, the common electrode layer may have an integral layer structure, or have a continuous structure with hollowed pattern. In such case, the common electrode is only used for display control, and is electrically connected with a signal line; and the signal line only provides a display drive data signal for the common electrode layer.

In the case where the common electrode layer is reused as the touch electrode layer, that is, the common electrode layer is used for display control as well as touch control, the common electrode layer includes multiple electrode blocks; and the metal layer includes multiple signal lines. The multiple electrode blocks have a one-to-one correspondence with the multiple signal lines, and each electrode block is connected to one signal line. When the common electrode layer is used for display control (during a display time period), the signal line is used for providing the display drive data signal for the electrode block electronically connected to the signal line. When the common electrode layer is used for touch control (during a touch time period), the signal line is used for providing a touch detection data signal for the electrode block electronically connected to the signal line. The touch detection is performed by detecting the self-capacitance between the common electrode layer and the finger.

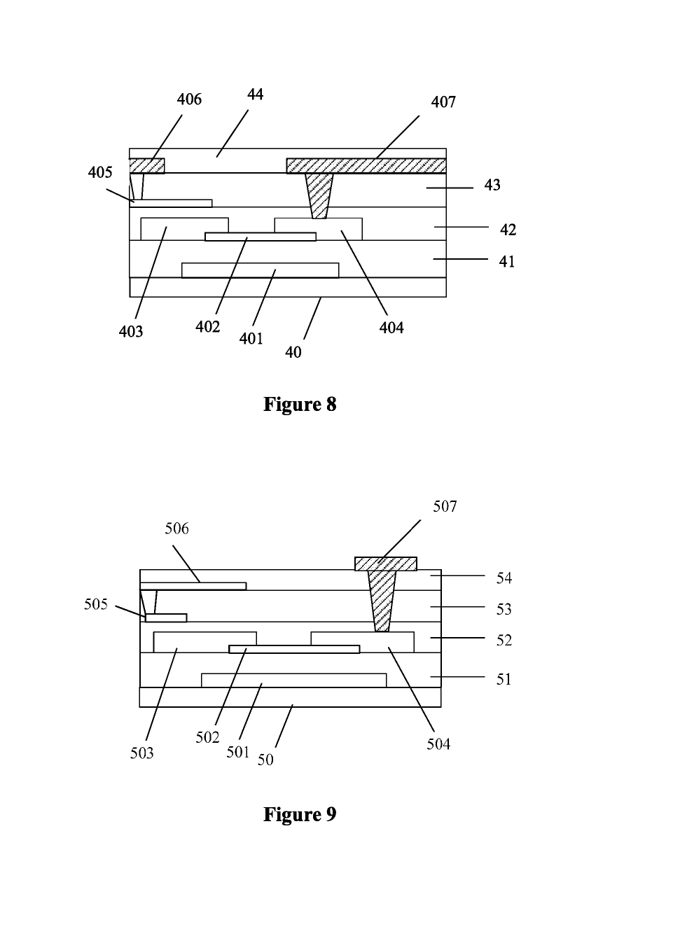

The common electrode layer has multiple arrangements depending on the structure of the array substrate. Three structures of the array substrate will be described in detail in conjunction with FIGS. 8 to 10.

As shown in FIG. 8, the array substrate is provided with a thin film transistor which is arranged on the surface of the substrate 40. The thin film transistor includes a gate 401 and a gate line (not shown in FIG. 8) arranged on the surface of the substrate 40; a gate dielectric layer 41 covering the gate 401 and the gate line; and an active region 402, a source 403 and a drain 404 arranged on the surface of the gate dielectric layer 41. The data line (not shown in FIG. 8) connected with the source 403 is arranged on the surface of the gate dielectric layer 41, and the data line is arranged in a same layer with the source 403.

In the array substrate shown in FIG. 8, the thin film transistor is arranged on the surface of the substrate 40. The thin film transistor is covered by a first insulating layer 42. A common electrode layer 405 is arranged on the surface of the first insulating layer 42. A second insulating layer 43 is arranged on the surface of the common electrode layer 405. A touch display wire 406 and a pixel electrode 407 are arranged on the surface of the second insulating layer 43. The pixel electrode 407 is electrically connected to the drain 404 of the thin film transistor through one or more via holes. The touch display wire 406 is electrically connected with a touch display electrode corresponding to the common electrode layer 406 through one or more via holes.

In the implementation shown in FIG. 8, the touch display wire 406 is arranged in the same layer with the pixel electrode 407, therefore the touch display wire 406 and the pixel electrode 407 may be prepared with a same conductive layer, the preparation process is simplified and the production cost is reduced. A third insulating layer 44 is further arranged on the pixel electrode 407 and the touch display wire 406. In order to avoid electromagnetic interference on the touch display wire 406, a wire shielding electrode (not shown in FIG. 8) may be arranged above the third insulating layer 44. The wire shielding electrode and the touch display wire 406 only partially overlap.

As shown in FIG. 9, the array substrate may be provided with a thin film transistor which is arranged on the surface of the substrate 50. The thin film transistor includes: a gate 501 and a gate line (not shown in FIG. 9) arranged on the surface of the substrate 50; a gate dielectric layer 51 covering the gate 501 and the gate line; and an active region 502, a source 503 and a drain 504 arranged on the surface of the gate dielectric layer 51. The data line (not shown in FIG. 9) connected with the source 503 is arranged on the surface of the gate dielectric layer 51, and the data line is arranged in a same layer with the source 503.

In the array substrate shown in FIG. 9, the thin film transistor is arranged on the surface of the substrate 50. The thin film transistor is covered by a first insulating layer 52. A touch display wire 505 is arranged on the surface of the first insulating layer 52. The touch display wire 505 is covered by a second insulating layer 53. A common electrode layer 506 is arranged on the surface of the second insulating layer 53. A third insulating layer 54 is arranged on the surface of the common electrode layer 506. A pixel electrode 507 is arranged on the surface of the third insulating layer 54. The pixel electrode 507 is electrically connected to the drain 504 of the thin film transistor through a via hole. The touch display wire 505 is electrically connected with a touch display electrode corresponding to the common electrode layer 506 through a via hole.

In order to avoid electromagnetic interference on the touch display wire 505, a wire shielding electrode (not shown in FIG. 9) may be arranged above the touch display wire 505. The wire shielding electrode and the touch display wire 505 only partially overlap.

Specifically, the second insulating layer 53 may be configured to have a two-insulating layer structure in which the wire shielding electrode is arranged between two insulating layers and above the touch display wire 505.

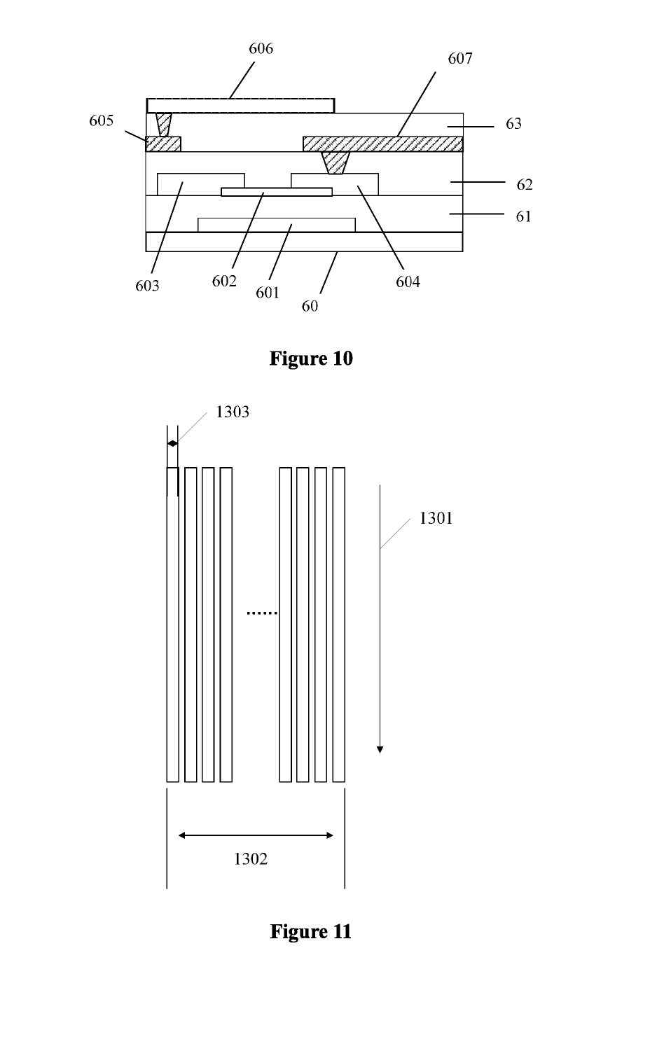

Further, as shown in FIG. 10, the array substrate may be provided with a thin film transistor which is arranged on the surface of the substrate 60. The thin film transistor includes: a gate 601 and a gate line (not shown in FIG. 10) arranged on the surface of the substrate 60; a gate dielectric layer 61 covering the gate 601 and the gate line; and an active region 602, a source 603 and a drain 604 arranged on the surface of the gate dielectric layer 61. The data line (not shown in FIG. 10) connected with the source 603 is arranged on the surface of the gate dielectric layer 61, and the data line is arranged in a same layer with the source 603.

In the array substrate shown in FIG. 10, the thin film transistor is arranged on the surface of the substrate 60. The thin film transistor is covered by a first insulating layer 62. A touch display wire 605 and a pixel electrode 607 are arranged on the surface of the first insulating layer 62. The pixel electrode 607 is electrically connected to the drain 604 of the thin film transistor through one or more via holes. A second insulating layer 63 is arranged on the surface of the touch display wire 605 and the pixel electrode 607. The common electrode layer 606 is arranged on the surface of the second insulating layer 63.

In the implementation shown in FIG. 10, the touch display wire 605 is arranged in a same layer with the pixel electrode 607, therefore the touch display wire 605 and the pixel electrode 607 may be prepared with a same conductive layer, the preparation process is simplified and the production cost is reduced. In order to avoid electromagnetic interference on the touch display wire 605, a wire shielding electrode (not shown in FIG. 10) may be arranged above the touch display wire 605. The wire shielding electrode and the touch display wire 605 only partially overlap. Specifically, the second insulating layer 63 may be configured to have a two-insulating layer structure in which the wire shielding electrode is arranged between two insulating layers and above the touch display wire 605.

In summary, an array substrate is provided according to the present disclosure, which includes a display area and a non-display area. Multiple gate lines, multiple data lines and a drive chip are arranged in the non-display area, and a common electrode layer is arranged in the display area. The gate lines are insulated from and intersect with the data lines to define multiple pixel units arranged in an array, and each of the multiple pixel units includes a pixel thin film transistor and a pixel electrode. The common electrode layer includes multiple insulated first touch units, and each of the multiple first touch units corresponds to multiple pixel units. A first fingerprint identification unit is arranged on the array substrate for identifying a fingerprint. Thus, as compared to the prior art in which the fingerprint identification unit is simply arranged in the electronic device, the array substrate according to the present disclosure in which the fingerprint identification unit is included has higher screen proportions and a smaller thickness.

With the above descriptions of the disclosed embodiments, the skilled in the art may achieve or use the present disclosure. Various modifications to the embodiments are apparent for the skilled in the art. The general principle herein can be implemented with other embodiments without departing from the spirit or scope of the disclosure. Therefore, the present disclosure should not be limited to the embodiments disclosed herein, but has the widest scope that is in conformity with the principle and the novel features disclosed herein.

1. An array substrate, comprising:
a display area and a non-display area, wherein:
a plurality of gate lines, a plurality of data lines and a drive chip are arranged in the non-display area, and a common electrode layer is arranged in the display area;
the plurality of gate lines are insulated from and intersect with the plurality of data lines to define a plurality of pixel units arranged in an array; and
each of the plurality of pixel units comprises a pixel thin film transistor and a pixel electrode;
the common electrode layer comprising a plurality of insulated first touch units, wherein each of the plurality of first touch units corresponds to a plurality of the pixel units; and
a first fingerprint identification unit arranged on the array substrate for identifying a fingerprint.

2. The array substrate according to claim 1, wherein the first fingerprint identification unit comprises a plurality of first fingerprint sensing units, and a longest side of the first fingerprint sensing unit has a length less than 100 μm.

3. The array substrate according to claim 2, wherein the first fingerprint sensing unit has a width of 40-50 μm.

4. The array substrate according to claim 1, wherein the first fingerprint identification unit has a length greater than or equal to 2 mm.

5. The array substrate according to claim 1, wherein the first fingerprint identification unit is arranged on at least one side of the display area.

6. The array substrate according to claim 1, wherein the first fingerprint identification unit is arranged on a side of the display area closest to the drive chip.

7. The array substrate according to claim 1, wherein the first fingerprint identification unit is arranged in a same layer with the first touch unit.

8. The array substrate according to claim 2, wherein the plurality of first fingerprint sensing units are arranged in an array, and each of the plurality of first fingerprint sensing units is electrically connected to the drive chip via a wire.

9. The array substrate according to claim 1, wherein the first fingerprint identification unit is a first swipe-type fingerprint sensing unit comprising a plurality of first fingerprint sensing units arranged sequentially in a single row, and wherein each of the plurality of first fingerprint sensing units is electrically connected to the drive chip via a wire.

10. The array substrate according to claim 1, wherein the first touch unit comprises insulated touch electrodes arranged in a same layer.

11. The array substrate according to claim 1, wherein:
the first touch unit comprises first touch electrodes and second touch electrodes;
the first touch electrodes are arranged sequentially in a first direction in the display area, and the second touch electrodes are arranged sequentially in a second direction in the display area.

12. A color film substrate, comprising:
a color film layer arranged in a display area and configured to color filter one or more light rays; and
a second fingerprint identification unit configured to identify a fingerprint.

13. The color film substrate according to claim 12 wherein the second fingerprint identification unit comprises a plurality of second fingerprint sensing units, and a longest side of the second fingerprint sensing unit has a length less than 100 μm.

14. The color film substrate according to claim 13, wherein the second fingerprint sensing unit has a width of 40-50 μm.

15. The color film substrate according to claim 12, wherein the second fingerprint identification unit has a length greater than or equal to 2 mm.

16. The color film substrate according to claim 12, wherein the fingerprint identification unit is arranged on at least one side of the display area.

17. The color film substrate according to claim 12, wherein the fingerprint identification unit is arranged on a side of the display area closest to the drive chip.

18. The color film substrate according to claim 13, wherein the plurality of second fingerprint sensing units are arranged in an array, and each of the plurality of second fingerprint sensing units is electrically connected to the drive chip via a wire.

19. The color film substrate according to claim 12, wherein the second fingerprint identification unit is a second swipe-type fingerprint sensing unit comprising a plurality of second fingerprint sensing units arranged sequentially in a single row, and each of the plurality of fingerprint sensing units is electrically connected to the drive chip via a wire.

20. A touch display device, comprising:
an array substrate and a color film substrate arranged opposite to each other; and
a display medium arranged between the array substrate and the color film substrate.

21. The touch display device according to claim 20, wherein the array substrate comprises:
a display area and a non-display area, wherein:
a plurality of gate lines, a plurality of data lines and a drive chip are arranged in the non-display area, and a common electrode layer is arranged in the display area;
the plurality of gate lines are insulated from and intersect with the plurality of data lines to define a plurality of pixel units arranged in an array; and
each of the plurality of pixel units comprises a pixel thin film transistor and a pixel electrode;
the common electrode layer comprising a plurality of insulated first touch units, wherein each of the plurality of first touch units corresponds to a plurality of the pixel units; and
a first fingerprint identification unit arranged on the array substrate for identifying a fingerprint.

22. The touch display device according to claim 20, wherein the color film substrate comprises:
a color film layer arranged in a display area and configured to color filter one or more light rays; and
a second fingerprint identification unit configured to identify a fingerprint.
